(19) United States
(12) Patent Application Publication
(10) Pub. No.: US 2025/0256414 A1
(43) Pub. Date: Aug. 14, 2025

(54) ELECTRIC HAIR CUTTING DEVICE WITH INERTIAL LOADING COMPENSATION

(71) Applicant: WAHL CLIPPER CORPORATION, Sterling, IL (US)

(72) Inventors: Gary Lee SNOW, Rock Falls, IL (US); Drew Paul MITCHELL, Polo, IL (US)

(21) Appl. No.: 19/046,853

(22) Filed: Feb. 6, 2025

Related U.S. Application Data
(60) Provisional application No. 63/552,815, filed on Feb. 13, 2024.

(51) Int. Cl. B26B 19/06; B26B 19/38

(52) U.S. Cl. CPC B26B 19/063; B26B 19/3846

(57) ABSTRACT

A hair clipper with inertial load compensation includes a housing having a first end and a second end opposite the first end, a bladeset mounted to the housing at the first end. The bladeset includes a stationary blade, a moving blade movable relative to the stationary blade along a cutting axis in first and second directions to produce a cutting action, a cam follower mounted to the moving blade, and a tensioner in contact with the cam follower and arranged to bias the cam follower into engagement with the moving blade. One or more compensation elements contact the cam follower and are arranged to bias the cam follower in a direction parallel to the cutting axis.

### RELATED APPLICATION

The present application claims the benefit under 35 USC 119 (e) of U.S. Provisional Application No. 63/552,815 filed Feb. 13, 2024, the entire contents of which are incorporated by reference herein.

### BACKGROUND

The present invention relates generally to electric hair cutting devices such as hair clippers and hair trimmers, and more specifically to mechanical systems associated with the reciprocating blades of such hair clippers and trimmers.

Electric hair cutting devices include a moving blade that laterally reciprocates in relation to a stationary blade to perform a cutting action. Both the moving blade and the stationary blade have teeth, and both blades are collectively referred to as the clipper bladeset. Hair caught between the teeth of the blades is sheared through movement of the moving blade relative to the stationary blade.

Contemporary electric hair cutting devices also include an electric motor that is powered by an on-board battery, and/or via a supply voltage from an outlet. The motor is mechanically coupled to the moving blade to produce the reciprocation of the moving blade via one of a variety of different mechanical linkage formats (e.g. eccentric cam arrangements, pivot arm arrangements, etc.).

It is desirable for the motor to reciprocate the moving blade as fast as possible as this leads to the most efficient hair cutting. However, higher speeds lead to higher power requirements, excessive wear on the mechanical system of the electric hair cutting device, and an undesirable temperature increase in the stationary blade which is in contact with the user's skin. As such, electric hair cutting devices are typically designed to run at a speed sufficient to provide a cutting action, but also to avoid the problems of higher speeds noted above.

In general, there are two primary forces which work against a driving force produced by the motor of the electric hair cutting device, namely, the inertial loading of the moving blade itself and the sliding frictional force between the moving blade and the stationary blade. The effects of these forces increase as speed increases, and hence lead to the above-mentioned increases in power consumption, wear, and blade temperature increases.

Inertial forces are largely dependent on the mass of the moving blade. While some attempts have been made to use lighter materials or different geometries to reduce mass, these solutions can affect the overall service life of the moving blade, the sharpness of its teeth, etc. In sum, it is not possible to reduce the mass of the moving blade to zero, and as such, inertial loading will always be present.

Frictional forces can also be reduced, but the very design of hair clippers and trimmers require that the moving blade be held in surface contact with the stationary blade, thereby making friction inherent in the design and a necessary drawback. Similar to mass in inertial loading, it is not possible to reduce friction to zero, and as such, frictional forces will always be present.

Accordingly, there is a need for an improved electric hair cutting device which includes a mechanical configuration that compensates for inertial and/or frictional loading, to allow the electric hair cutting device to run at higher speeds but with a reduction or elimination of the drawbacks mentioned above.

### SUMMARY

The above-listed need is met or exceeded by an electric hair cutting device having provisions for reducing or eliminating inertial loads created by the moving blade during operation. An embodiment of such an electric hair cutting device includes a housing having a first end and a second end opposite the first end. A bladeset is mounted to the housing at the first end. The bladeset includes a stationary blade and a moving blade. The moving blade is movable relative to the stationary blade along a cutting axis in first and second directions to produce a cutting action.

The bladeset also includes a cam follower mounted to the moving blade and a tensioner. The tensioner is in contact with the cam follower and arranged to bias the cam follower into engagement with the moving blade. At least one compensation element contacts the cam follower and is arranged to bias the cam follower in a direction parallel to the cutting axis.

The at least one compensation element may include a first compensation element and a second compensation element, and in such a configuration, the first and second compensation elements may be arranged in an opposed spaced relationship.

In an embodiment, the cam follower includes a base portion and a cam receiving portion extending upwardly from the base portion. The tensioner includes a pair of spring arms respectively received in a pair of spring receiving structures formed on the base portion of the cam follower. The at least one compensation element contacts at least one compensation element receiving structure formed on the cam receiving portion of the cam follower.

In an embodiment including first and second compensation elements, the first and second compensation elements may contact opposing sides of a cam receiving portion of the cam follower, respectively. The first compensation element is received by a first compensation element receiving structure of the cam follower. The second compensation element is received by a second compensation element receiving structure of the cam follower.

A spring force stored by the first compensation element increases and a spring force stored by the second compensation element decreases when the moving blade moves in the first direction. The spring force stored by the first compensation element decreases and the spring force stored by the second compensation element increases when the moving blade moves in the second direction.

In an embodiment, the at least one compensation element may be a compression spring. However, it is contemplated that any mechanical expedient which functions according to Hooke's Law may be employed as the at least one compensation element.

The above listed need is also met or exceeded by an electric hair cutting device having dual biasing elements acting on a cam follower along differing directions. An embodiment of such an electric hair cutting device includes a housing having a first end and a second end opposite the first end. A bladeset is mounted to the housing at the first end. The bladeset includes a stationary blade and a moving blade. The moving blade is movable relative to the stationary blade along a cutting axis.

A cam follower is mounted to the moving blade. The cam follower includes a pair of spring receiving structures and at least one compensation element receiving structure. The bladeset also includes tensioner including a pair of spring arms respectively received in the pair of first spring receiving structures. At least one compensation element is received by the at least one compensation element receiving structure.

In an embodiment, the at least one compensation element has a first end and a second end. The second end is movable relative to the first end. The second end is received by the at least one compensation element receiving structure. The first end is fixedly mounted to a mounting structure within the housing. The mounting structure may be formed on a blade guide mounted to the housing.

In an embodiment, the at least one compensation element may include a first compensation element and a second compensation element in an opposed spaced relation. The at least one compensation element receiving structure includes a first compensation element receiving structure, and a second compensation element receiving structure. The first and second compensation elements may be compression springs.

In an embodiment, the cam follower includes a base portion and a cam receiving portion extending upwardly from the base portion. The first and second compensation element receiving structures are formed on the cam receiving structure. The pair of spring receiving structures are formed on the base portion of the cam follower.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective view of an exemplary embodiment of an electric hair cutting device constructed according to the teachings herein;

FIG. 2 is a partial side cross section of the electric hair cutting device of FIG. 1 taken along the line 2-2 and in the direction generally indicated;

FIG. 3 is a perspective view of a bladeset of the electric hair cutting device of FIG. 1, associated with a portion of the remainder of the electric hair cutting device;

FIG. 4 is a perspective view of the cam follower of the bladeset of FIG. 3;

FIGS. 5-7 are front views of an assembly of the cam follower of FIG. 4 with the remainder of the electric hair cutting device;

FIG. 8 is a free body diagram of a moving blade of the electric hair cutting device of FIG. 1; and

FIG. 9 is graph illustrating the inertial loading on the moving blade of FIG. 8.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

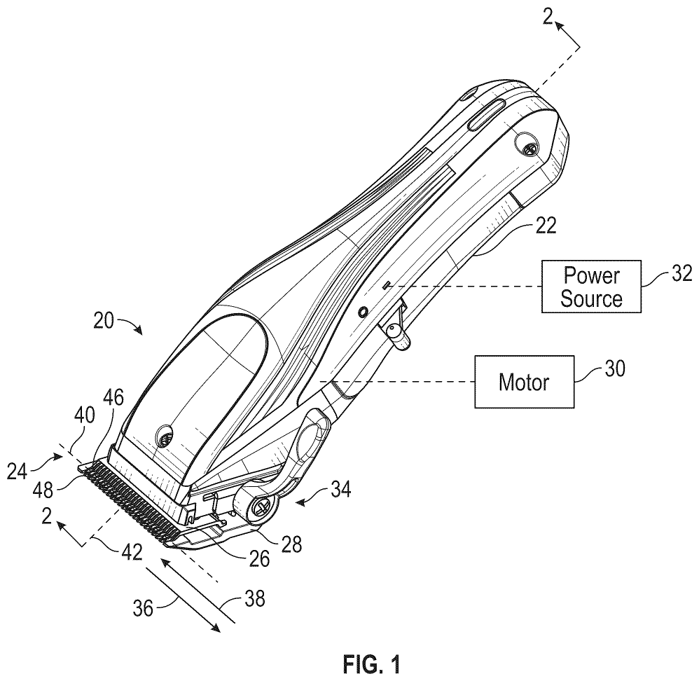

Turning now to the drawings, FIG. 1 illustrates an exemplary embodiment of an electric hair cutting device embodied herein for non-limiting example as a hair clipper 20. Hair clipper 20 includes a housing 22 having a first end and a second end. A bladeset 24 is mounted at the first end. Bladeset 24 includes a moving blade 26 which moves relative to a stationary blade 28 to produce a hair cutting action. While the following description will be provided in the context of a hair clipper of the type shown in FIG. 1, the invention is not limited to the device illustrated, and it is envisioned that the teachings herein may be readily applied to other devices such as hair trimmers, or any electric hair cutting device having a reciprocating blade.

Hair trimmer 20 includes an internal electric motor 30 powered via a power source 32. It will be recognized from the description herein that the invention is not constrained to a particular power source or a particular motor type. For example, power source 32 may be embodied by an internal battery carried by housing 22 or may be an external power source such as a supply voltage provided by a wall outlet.

A mechanical linkage (not shown) connects motor 30 to bladeset 24 to induce a reciprocating motion to moving blade 26 relative to stationary blade 28 to provide a cutting action. More specifically, moving blade 26 is operable to reciprocate in first and second directions 36, 38 along a cutting axis 40. Cutting axis 40 is defined generally at the line defined by the tips of a plurality of moving teeth 46 of moving blade 26 as located relative to a plurality of stationary teeth 48 of stationary blade 28.

Hair clipper 20 also includes an adjustment mechanism 34 for adjusting a relative distance between the tips of the teeth of moving blade 26 and the tips of the teeth of stationary blade 28. In the illustrated embodiment, adjustment mechanism 34 moves stationary blade 28 relative to moving blade 26 along a longitudinal axis 42 of hair clipper 20.

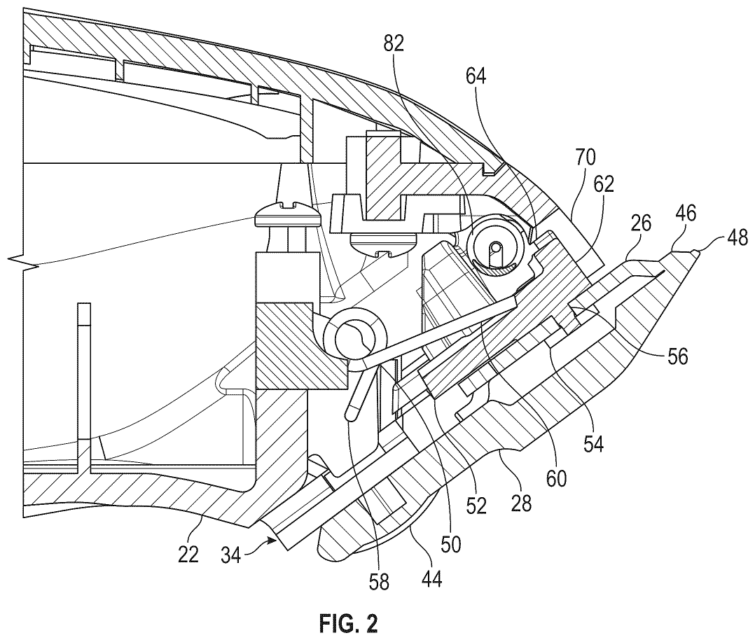

Turning now to FIG. 2, stationary blade 28 is mounted to a portion of adjustment mechanism 34 with one or more fasteners 44. Stationary teeth 48 form a leading end of stationary blade 28 as shown. Moving blade 26 is positioned above stationary blade 28 and held against stationary blade 28 via a spring force provided by a tensioner 50. Like stationary blade 28, a plurality of moving teeth 46 form a leading end of moving blade 26.

Tensioner 50 is illustrated as a spring but may be embodied as any mechanical expedient operable to bias moving blade 26 into contact with stationary blade 28 such that moving blade 26 does not come out of sliding contact with stationary blade 28 during operation. Tensioner 50 includes a retainer portion 58 and one or more spring arms 60. Retainer portion 58 is mounted to housing 22, and spring arms 60 extend outwardly and exert a force against a cam follower 52.

Cam follower 52 is in turn coupled to moving blade 26. Cam follower 52 is operably connected to the above-introduced mechanical linkage (not shown) between motor 30 (see FIG. 1) and cam follower 52. In an instance where motor 30 is embodied by a rotary motor and where the mechanical linkage is an eccentric cam, cam follower 52 engages this cam to convert the rotary motion of the cam into a linear reciprocating motion.

Cam follower 52 is connected to moving blade 26 such that it does not move relative to moving blade 26. In the illustrated embodiment, this connection is achieved via an extension of a projection 54 of cam follower 52 into a similarly shaped opening 56 of moving blade 26. Those of skill in the art will readily appreciate that the configuration of connection between moving blade 26 and cam follower 52 may be readily changed to adapt to different blade and cam follower designs.

Cam follower 52 includes a linear guide rail 62 that is received in a corresponding linear guide channel 64 of a blade guide 70 of hair clipper 20. Guide rail 62 is constrained to a linear motion within guide channel 64 in the manner described for example in U.S. Pat. No. 9,144,911 to Arndt et al. titled Linear Drive System for Hair Clippers, the disclosure of which is incorporated by reference herein in its entirety.

Blade guide 70 is illustrated as a separate component mounted to housing 22 via fasteners 72. However, it is also contemplated that blade guide 70 may be integrally formed with housing 22. In general, blade guide 70 may take the form of any construction capable of constraining moving blade 26 to a linear reciprocating motion relative to stationary blade 28.

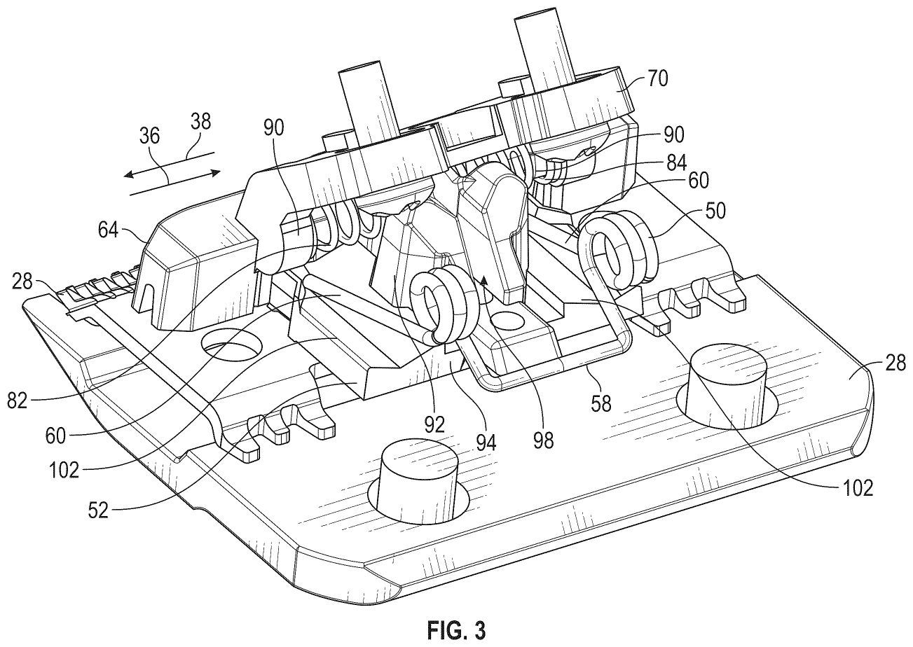

At least one compensation element is mounted between blade guide 70 and cam follower 52, and in the illustrated embodiment, first and second compensation elements 82, 84 are utilized (see also FIG. 3). In other embodiments, a single compensation element may be employed. A force balance benefit arises by including opposed first and second compensation elements, 82, 84, but in any case, a single compensation element could also be employed. As will be described in greater detail below, first and second compensation elements 82, 84 exert a compensation force against cam follower 52 during the reciprocation of cam follower 52. This compensation force serves to reduce or in some cases entirely cancel the inertial forces resulting from the acceleration of moving blade 26 and the componentry which moves therewith during operation.

In the illustrated embodiment, first and second compensation elements 82, 84 are compression springs, however, first and second compensation elements 82, 84 may take the form of any structure that provides a reactionary force to the movement of moving blade 26. In the illustrated embodiment using compression springs, this reactionary force may be defined according to Hooke's Law. As one alternative example to a compression spring, however, first and second compensation elements 82, 84 may be embodied as viscoelastic devices. As another alternative example, first and second compensation elements 82, 84 may be embodied as a viscoelastic medium.

With reference to FIG. 3, first and second compensation elements 82, 84 are arranged such that they act on opposing sides of cam follower 52 and exert forces thereon in directions parallel to the cutting axis 40 (see FIG. 1). In the illustrated embodiment, compensation elements 82, 84 are identical and are symmetrically arranged relative to a mid-plane of cam follower 52. In particular, first and second compensation elements 82, 84 act on opposing sides of a cam receiving portion 92 extending upwardly from base portion 94 of cam follower 52. In the illustration shown in FIG. 3, cam follower is at an effective zero or midpoint of its stroke. At this location, each of first and second compensation elements 82, 84 exert equal and opposite forces against cam receiving portion 92.

As a result of this symmetrical arrangement about cam receiving portion 92, and when moving blade 26 and cam follower reciprocate along cutting axis 40 (see FIG. 1) in first and second cutting directions 36, 38, energy is reciprocally stored and discharged by first and second compensation elements 82, 84. For example, when moving blade 26 and cam follower 52 move in first cutting direction 36 (see FIG. 1), first compensation element 82 is compressed, and thereby the spring force stored thereby is increased.

Likewise, when moving blade 26 and cam follower 52 move in second cutting direction 38 (see FIG. 1), first compensation element 82 lengthens by exerting a spring force against cam follower 52, while second compensation element 84 is compressed to thereby store energy, all according to Hooke's Law. This cycle repeats itself as moving blade 26 and cam follower 52 reciprocate in first and second cutting directions 36, 38 because of the above introduced eccentric cam (not shown) rotating within a cam slot 98 of cam follower 52.

A first end of each of first and second compensation elements 82, 84 is received on corresponding post-like mounting structures 90 formed on blade guide 70. It is also contemplated, however, that mounting structures 90 may be formed directly on an interior of housing 22 and may take any form necessary to receive the first ends of first and second compensation elements 82, 84 to allow the motion of first and second compensation elements 82, 84 as described herein. A second end opposite the first end of each of first and second compensation elements 82, 84 is received on cam receiving portion 92. It is also contemplated first and second compensation elements 82, 84 may directly contact moving blade 26 or any structure fixed relative thereto.

Still referring to FIG. 3, spring arms 60 are received in a pair of spring receiving structures 102. Spring receiving structures 102 are formed on base portion 94 of cam follower 52. In the illustrated embodiment, spring receiving structures 102 are generally ramped depressions. However, they may take any form necessary to receive spring arms 60 to allow the functionality thereof as described herein.

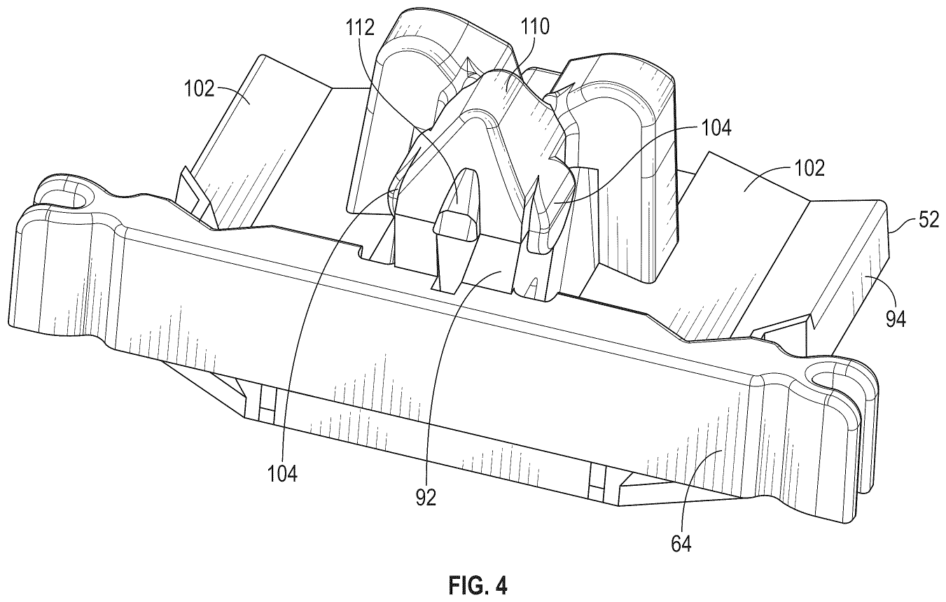

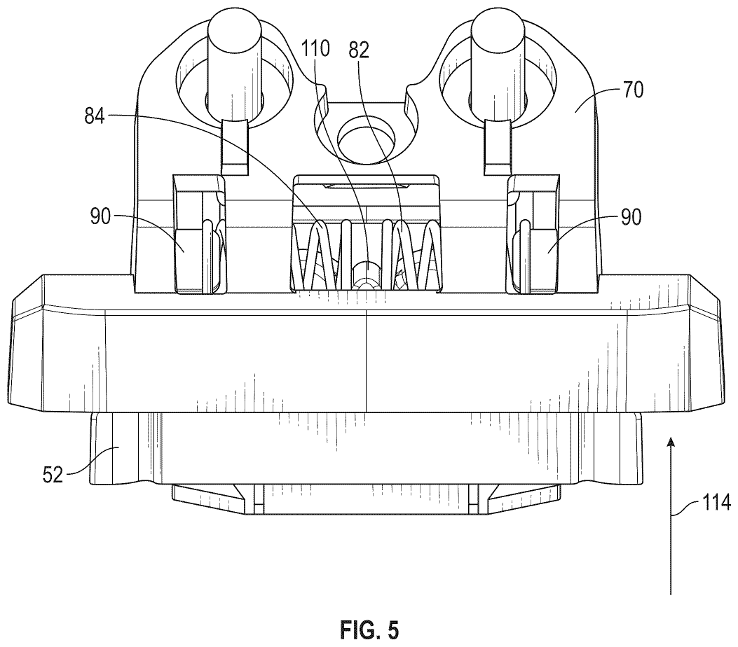

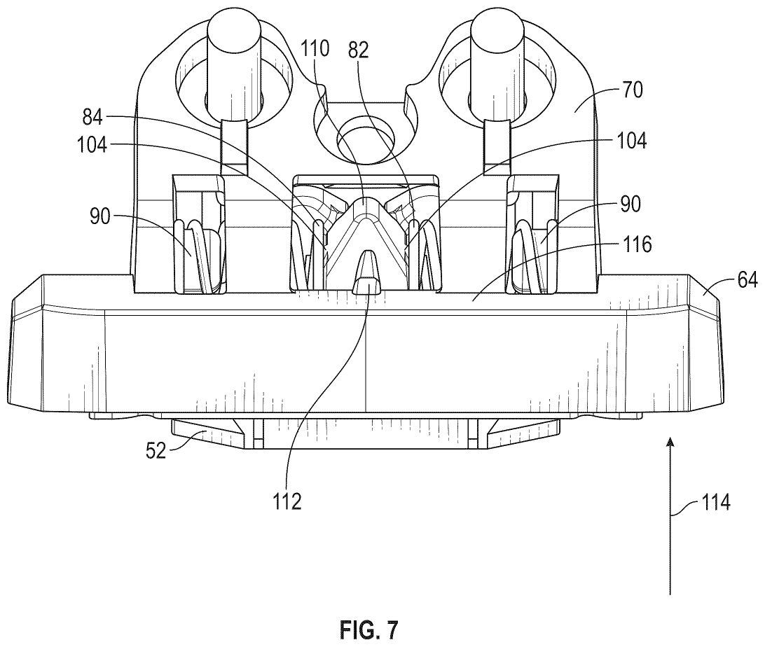

With reference now to FIG. 4, a pair of compensation element receiving structures 104 are formed on cam receiving portion 92 of cam follower 52. Compensation element receiving structures 104 are ramped projections sized to be received within the inner diameter of each of first and second compensation elements 82, 84 (see also FIG. 3). Cam receiving portion 92 converges to a tip 110 as shown. The ramped sides of tip 110 generally align with the ramped faces of compensation element receiving structures 104 to form generally continuous ramped surfaces on either side of cam receiving portion 92. A ramped tab 112 for retaining cam follower 92 on blade guide 70 (see FIG. 7) is also provided on cam receiving portion 92. As will be explained relative to FIGS. 5-7, these ramped surfaces facilitate the assembly cam follower 52 when assembling hair clipper 20.

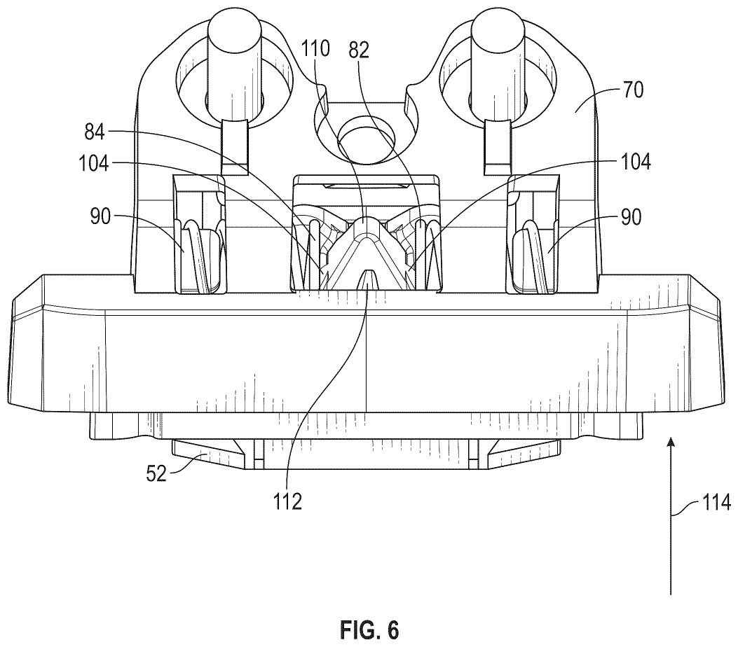

Indeed, and with reference to FIG. 5, as cam follower 52 is inserted into blade guide 70 in direction 114 as shown, tip 110 will begin to spread first and second compensation elements 82, 84 apart and the ends thereof will begin to slide along the ramped opposing surfaces of cam receiving portion 92 of cam follower 52. As shown in FIG. 6, continued movement of cam follower 52 in direction 114 will continue to spread first and second compensation elements 82, 84 apart. As shown in FIG. 7, continued movement of cam follower 52 in direction 114 will ultimately seat first and second compensation elements 82, 84 on their corresponding compensation element receiving structures 104 and seat tab 112 on an upper surface 116 of guide channel 64. As such, cam follower 52 is self-centering during installation as a result of the aforementioned ramped surfaces on the compensation element receiving structures 104.

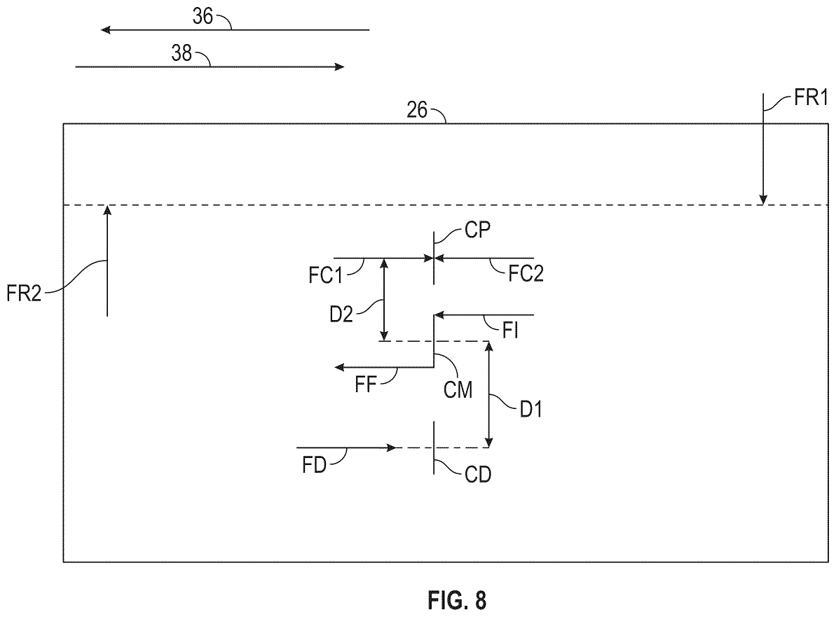

FIG. 8 illustrates a schematic free body diagram of moving blade 26 at a point in which it has completed its movement in first direction 36 and is beginning to move back in second direction 38. A driving force FD is imparted to moving blade 26 from motor 30 (see FIG. 1) in general at the point of contact CD between the above discussed eccentric cam (not shown) and cam follower 52 (see FIG. 3). Point CD is spaced a distance D1 from a center of mass CM of moving blade 26. A resultant frictional force FF from the frictional contact surfaces between moving blade 26 and stationary blade 28 (see FIG. 1) and all other frictional contact surfaces resulting from the reciprocation of moving blade 26 also acts on the center of mass CM. A resultant inertial force FI resulting from the inertia of moving blade 26 and cam follower 52 also act on the center of mass CM.

Opposing forces FC1, FC2 applied by first and second compensation elements 82, 84 (see FIG. 3) act at a point CP spaced a distance D2 from the center of mass CM. Point CP represents the point at which first and second compensation elements 82, 84 contact cam receiving portion 92 of cam follower 52 (see FIG. 3). Opposing reactionary forces FR1, FR2 act along a line generally representing the contact of guide rail 62 and guide channel 64 (see FIG. 2) as a reaction to the moment about the center of mass CM caused by the driving force FD and compensation forces FC1, FC2.

As may be surmised by inspection of FIG. 8, if distance D2 is minimized or reduced to zero, FC1 and FC2 will not produce a moment about the center of mass CM, and hence will not increase the reactionary forces FR1, FR2, thereby reducing wear at these points of contact. It is contemplated herein that point CP may be situated directly linearly above the center of mass CM by arranging the location of where first and second compensation elements 82, 84 act on cam follower 52 to eliminate any moment about the center of mass CM caused by FC1, FC2.

At the point in the stroke of moving blade 26 shown in FIG. 8, and referring also to FIG. 3, first compensation element 82 has stored a force FC1 greater than the force FC2 exerted by second compensation element 84. Indeed, at the stroke midpoint generally illustrated in FIG. 3, each of first and second compensation elements 82, 84 have been compressed to some extent, but in this equilibrium position, each compensation element forces FC1 and FC2 are equal and opposite. As moving blade 26 moves in first cutting direction 36, first compensation element 82 is shortened, and the spring force is increased according to Hooke's Law as the product of the change in length of first compensation element 82 and the spring constant k of first compensation element 82. As this occurs, second compensation element 84 is lengthened, such that it first achieves its free length and then displaces an additional value to lengthen beyond its free length. This continues until movement in the first cutting direction 36 stops.

The change in length of first compensation element 82 relative to its free length is greater than the change in length of the second compensation element 84 relative to its free length, and hence FC1 is greater than FC2 at the end of the stroke. This reverses as moving blade 26 moves in second cutting direction 38. The forces FC1 and FC2 act primarily to offset or entirely eliminate the inertial forces FI and frictional forces FF acting on the center of mass CM. These compensation forces FC1, FC2 can be tuned by selecting appropriate spring constants k for each of first and second compensation elements 82, 84.

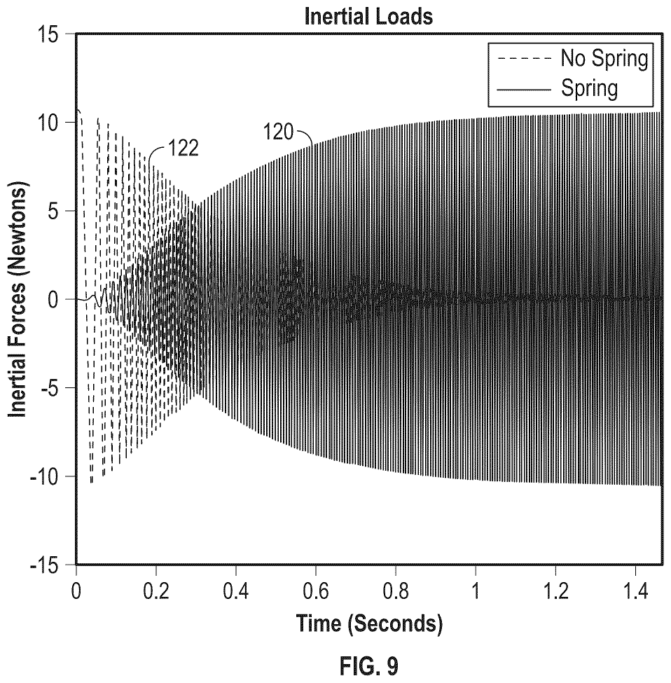

FIG. 9 illustrates two plots 120, 122 of the inertial forces acting on moving blade 26. Plot 120 illustrates a system that does not employ a compensation element as described herein. As may be seen from this plot, inertial forces increase over time to a constant sinusoidal amplitude over time. Plot 122 illustrates a system represented by the embodiment illustrated herein. As may be seen, the inertial forces generally decrease over time to a minimal constant, and near zero, value. A reduction in the inertial loads has the advantage of allowing higher speeds without the increased impact of increased wear and heat.

All references, including publications, patent applications, and patents cited herein are hereby incorporated by reference to the same extent as if each reference were individually and specifically indicated to be incorporated by reference and were set forth in its entirety herein.

The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric hair cutting device, comprising:
a housing having a first end and a second end opposite the first end;
a bladeset mounted to the housing at the first end, the bladeset comprising:
a stationary blade;
a moving blade movable relative to the stationary blade along a cutting axis in first and second directions to produce a cutting action;
a cam follower mounted to the moving blade; and
a tensioner in contact with the cam follower and arranged to bias the cam follower into engagement with the moving blade;
at least one compensation element in contact with the cam follower and arranged to bias the cam follower in a direction parallel to the cutting axis.

2. The electric hair cutting device of claim 1, wherein the at least one compensation element includes a first compensation element and a second compensation element, the first and second compensation elements arranged in an opposed spaced relationship.

3. The electric hair cutting device of claim 1, wherein the cam follower includes a base portion and a cam receiving portion extending upwardly from the base portion.

4. The electric hair cutting device of claim 3, wherein the tensioner contacts the base portion, and wherein the at least one compensation element contacts the cam receiving portion.

5. The electric hair cutting device of claim 4, wherein the tensioner includes a pair of spring arms respectively received in a pair of spring receiving structures formed on the base portion of the cam follower.

6. The electric hair cutting device of claim 4, wherein the at least one compensation element contacts at least one compensation element receiving structure formed on the cam receiving portion of the cam follower.

7. The electric hair cutting device of claim 2, wherein the first and second compensation elements contact opposing sides of a cam receiving portion of the cam follower, respectively.

8. The electric hair cutting device of claim 7, wherein the first compensation element is received by a first compensation element receiving structure of the cam follower, and wherein the second compensation element is received by a second compensation element receiving structure of the cam follower.

9. The electric hair cutting device of claim 8, wherein a spring force stored by the first compensation element increases and a spring force stored by the second compensation element decreases when the moving blade moves in the first direction.

10. The electric hair cutting device of claim 9, wherein the spring force stored by the first compensation element decreases and the spring force stored by the second compensation element increases when the moving blade moves in the second direction.

11. The electric hair cutting device of claim 1, wherein the at least one compensation element is a compression spring.

12. An electric hair cutting device, comprising:
a housing having a first end and a second end opposite the first end;
a bladeset mounted to the housing at the first end, the bladeset comprising:
a stationary blade;
a moving blade movable relative to the stationary blade along a cutting axis;
a cam follower mounted to the moving blade, the cam follower including a pair of spring receiving structures and at least one compensation element receiving structure; and
a tensioner including a pair of spring arms respectively received in the pair of first spring receiving structures;
at least one compensation element received by the at least one compensation element receiving structure.

13. The electric hair cutting device of claim 12, wherein the at least one compensation element has a first end and a second end, the second end movable relative to the first end, the second end received by the at least one compensation element receiving structure.

14. The electric hair cutting device of claim 13, wherein the first end is fixedly mounted to a mounting structure within the housing.

15. The electric hair cutting device of claim 14, wherein the mounting structure is formed on a blade guide mounted to the housing.

16. The electric hair cutting device of claim 12, wherein the at least one compensation element includes a first compensation element and a second compensation element in an opposed spaced relation, and wherein the at least one compensation element receiving structure includes a first compensation element receiving structure, and a second compensation element receiving structure.

17. The electric hair cutting device of claim 16, wherein the first and second compensation elements are compression springs.

18. The electric hair cutting device of claim 16, wherein the cam follower includes a base portion and a cam receiving portion extending upwardly from the base portion.

19. The electric hair cutting device of claim 18, wherein the first and second compensation element receiving structures are formed on the cam receiving structure.

20. The electric hair cutting device of claim 19, wherein the pair of spring receiving structures are formed on the base portion of the cam follower.
